(19) United States
(12) Patent Application Publication
(10) Pub. No.: US 2010/0054306 A1
(43) Pub. Date: Mar. 4, 2010

(54) SIGNAL TRANSMITTING METHOD AND DEVICE AND INFORMATION DETECTING DEVICE

(75) Inventors: Jong Won Kim, Daejeon (KR); Sang Sung Choi, Daejeon (KR); Kwang Roh Park, Daejeon (KR)

Correspondence Address: Muncy, Geissler, Olds & Lowe, PLLC, P.O. BOX 1364, FAIRFAX, VA, 22038-1364, US

(73) Assignee: Electronics and Telecommunications Research Institute, Daejeon (KR)

(21) Appl. No.: 12/329,875

(22) Filed: Dec. 8, 2008

(30) Foreign Application Priority Data
Aug. 27, 2008 (KR) 10-2008-0084101

(51) Int. Cl. H04B 1/69; H04B 1/10

(52) U.S. Cl. 375/130; 375/346; 375/E01.001

(57) ABSTRACT

A signal transmitting device detects information on respective frequencies of a plurality of subcarriers configuring an interference signal and information on respective voltage values of the subcarrier from the received interference signal, and modulates data according to the ultra-wideband scheme through subcarriers of part of predetermined bandwidths based on frequency information and voltage value information to generate ultra-wideband signals. Accordingly, signal interference with a heterogeneous communication device can be reduced by detecting an interference signal when an absolute value of the interference signal is small or noise power of the interference signal is large.

### CROSS-REFERENCE TO RELATED APPLICATION

This application claims priority to and the benefit of Korean Patent Application No. 10-2008-0084101 filed in the Korean Intellectual Property Office on Aug. 27, 2008, the entire contents of which are incorporated herein by reference.

### BACKGROUND OF THE INVENTION

(a) Field of the Invention

The present invention relates to a signal transmitting method and device, and an information detecting device. Particularly, the present invention relates to an ultra-wideband-based signal transmitting method and device, and an interference signal information detecting device.

This work was supported by the IT R&D program of MIC/IITA [2006-S-071-03, UWB Solution Development for Ultra Speed Mutimedia Transmission].

(b) Description of the Related Art

The ultra-wideband (UWB) communication scheme represents a radio communication method for transmitting data through a wide frequency bandwidth with a lower power in a local area. The ultra-wideband communication scheme enables transmission of high-capacity data with high speed and low power consumption compared to the existing local area communication networks such as the wireless local area network (wireless LAN), the Wi-Fi, and the Bluetooth.

The ultra-wideband communication scheme is used to connect personal computers, peripherals, and home appliances through radio interfaces in the wireless personal area network (WPAN), or is applied to various fields such as fluoroscopic radar, high-precision position measurement a car crash preventing device, or a human body monitoring device.

However, since the ultra-wideband communication scheme uses a broad frequency bandwidth, it causes interference with a radio frequency used by other communication schemes.

Also, the above-noted conventional interference signal detecting method for solving the interference cannot detect interference signals when the absolute value of the interference signal is small or the intensity of noise power of the interference signal is large.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for preventing signal interference between an ultra-wideband scheme based communication device and a heterogeneous communication device.

An exemplary embodiment of the present invention provides a method for transmitting a signal following an ultra-wideband scheme including: detecting information on respective frequencies of a plurality of subcarriers configuring an interference signal from the received interference signal and information on respective voltage values of the plurality of subcarriers; and generating an ultra-wideband signal by modulating data according to the ultra-wideband scheme through subcarriers of part of the bandwidth from among a plurality of predetermined bandwidths based on information on the frequency and information on the voltage.

The detecting includes generating a plurality of subcarrier data corresponding to a plurality of subcarriers by Fourier transforming the interference signal, and detecting information on the frequency and information on the voltage value from the plurality of respective subcarrier data.

The generating includes: generating number information on the voltage values having digressed from the range of a predetermined allowable voltage according to information on the voltage value; when a value corresponding to the number information is greater than a predetermined threshold value, extracting information on a frequency of a first subcarrier corresponding to a voltage value having digressed from the range of the allowable voltage value based on information on the frequency and information on the voltage value; and generating the ultra-wideband signal by modulating the data according to the ultra-wideband scheme through the subcarrier of part of the bandwidth excluding the bandwidth to which the frequency of the first subcarrier belongs from among the plurality of bandwidths according to information on the frequency of the first subcarrier.

Another embodiment of the present invention provides a device for transmitting a signal following an ultra-wideband scheme including: a data generator for generating data; an interference signal detecting module for generating interference signal detecting information including information on respective voltage values of a plurality of subcarriers configuring an interference signal from the received interference signal; and an ultra-wideband communication module for generating an ultra-wideband signal by modulating the transmission data according to the ultra-wideband scheme by using the interference signal detecting information.

The interference signal detecting module includes: a Fourier transformer for generating a plurality of subcarrier data corresponding to a plurality of subcarriers by Fourier transforming the interference signal; and a voltage detector for detecting information on the respective voltage values of the plurality of subcarriers from the plurality of subcarrier data.

The voltage detector includes: a maximum value detector for extracting a first subcarrier data having the greatest voltage value from among the plurality of subcarrier data, and extracting voltage value information of a first subcarrier corresponding to the first subcarrier data from the first subcarrier data; and a subcarrier eliminator for outputting part of the subcarrier data from among the plurality of subcarrier data by eliminating the first subcarrier data from the plurality of subcarrier data.

The voltage detector further includes a data controller for transmitting the plurality of subcarrier data or the part of subcarrier data to the voltage detector and the subcarrier eliminator.

Yet another embodiment of the present invention provides a device for detecting information from a signal including: a receiver for receiving an interference signal; a Fourier transformer for generating a plurality of subcarrier data corresponding to a plurality of subcarriers by Fourier transforming the interference signal; and a voltage detector for detecting information on respective frequencies of the plurality of subcarriers and information on respective voltage values of the plurality of subcarriers based on the plurality of subcarrier data.

The voltage detector includes a maximum value detector for extracting subcarrier data having the greatest voltage value from among the plurality of subcarrier data, and detecting frequency information of the subcarrier corresponding to the subcarrier data from the subcarrier data and voltage value information of the subcarrier.

The voltage detector further includes a subcarrier eliminator for outputting part of subcarrier data by eliminating the subcarrier data from the plurality of subcarrier data.

According to the present invention, signal interference with a heterogeneous communication device can be reduced by detecting an interference signal when an absolute value of the interference signal is small or an intensity of noise power of the interference signal is great, by detecting respective voltage values of a plurality of subcarriers forming the interference signal.

### BRIEF DESCRIPTION OF THE DRAWINGS

FIG. 1 shows an ultra-wideband network according to an exemplary embodiment of the present invention.

FIG. 2 shows a bandwidth group allocation method according to an exemplary embodiment of the present invention.

FIG. 3 shows a UWB communication device according to an exemplary embodiment of the present invention.

FIG. 4 shows an interference signal detecting module according to an exemplary embodiment of the present invention.

FIG. 5 shows a voltage detector according to another exemplary embodiment of the present invention.

FIG. 6 shows a voltage detector according to another exemplary embodiment of the present invention.

FIG. 7 shows an ultra-wideband signal transmitting method according to an exemplary embodiment of the present invention.

FIG. 8 shows an interference signal detecting information generating method according to an exemplary embodiment of the present invention.

FIG. 9 shows an ultra-wideband signal generating method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

A signal transmitting method and device and an information detecting device according to an exemplary embodiment of the present invention will now be described with reference to accompanying drawings.

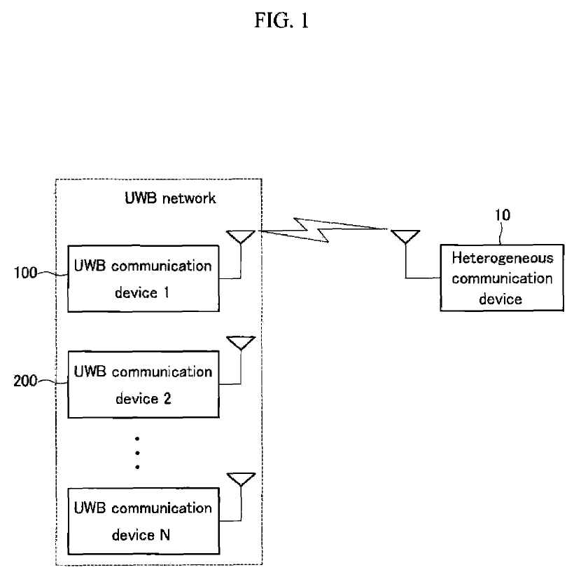

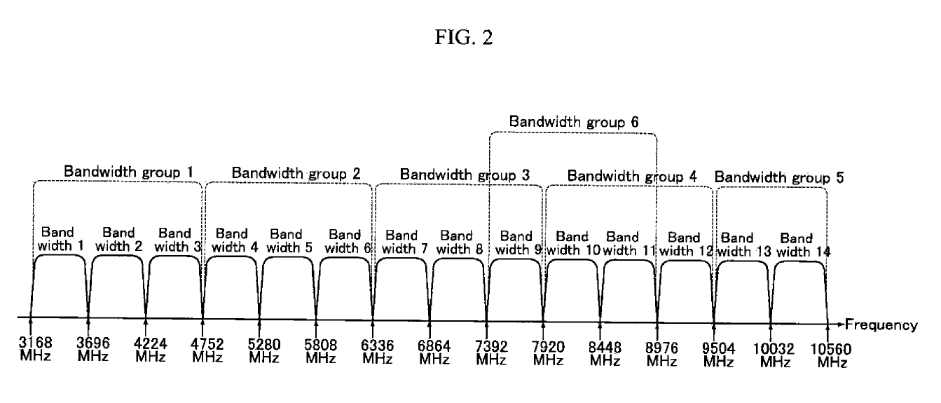

An ultra-wideband network according to an exemplary embodiment of the present invention will now be described with reference to FIG. 1 and FIG. 2.

FIG. 1 shows an ultra-wideband network according to an exemplary embodiment of the present invention.

As shown in FIG. 1, the ultra-wideband network includes a plurality of ultra-wideband (UWB) communication devices 100 and 200, and communication between the UWB communication devices 100 and 200 follows the ultra-wideband (UWB) scheme.

A method for allocating a frequency bandwidth for the ultra-wideband network to a plurality of bandwidth groups according to an exemplary embodiment of the present invention will now be described with reference to FIG. 2.

FIG. 2 shows a bandwidth group allocation method according to an exemplary embodiment of the present invention.

As shown in FIG. 2, the frequency bandwidth (an entire frequency bandwidth) of 3.1 GHz-10.6 GHz for the ultra-wideband network is divided into 14 bandwidths. In this instance, the respective frequency ranges of the 14 bandwidths follow Table 1.

TABLE 1

| Bandwidths | Frequency ranges |
|---|---|
| Bandwidth 1 | 3168~3696 MHz |
| Bandwidth 2 | 3696~4224 MHz |
| Bandwidth 3 | 4224~4572 MHz |
| Bandwidth 4 | 4572~5280 MHz |
| Bandwidth 5 | 5280~5808 MHz |
| Bandwidth 6 | 5808~6336 MHz |
| Bandwidth 7 | 6336~6864 MHz |
| Bandwidth 8 | 6864~7392 MHz |
| Bandwidth 9 | 7392~7920 MHz |
| Bandwidth 10 | 7920~8448 MHz |
| Bandwidth 11 | 8448~8976 MHz |
| Bandwidth 12 | 8976~9504 MHz |
| Bandwidth 13 | 9504~10032 MHz |
| Bandwidth 14 | 10032~10560 MHz |

As shown in FIG. 2 and Table 1, the entire frequency bandwidth is divided into 14 bandwidths from the first bandwidth to the fourteenth bandwidth.

Next, the entire frequency bandwidth is allocated to 6 bandwidth groups based on the 14 bandwidths, and the respective 6 bandwidth groups include a plurality of bandwidths. In this instance, the bandwidths included in the 6 bandwidth groups follow Table 2.

TABLE 2

| Bandwidth groups | Included bandwidths |
|---|---|
| Bandwidth group 1 | Bandwidths 1, 2, and 3 |
| Bandwidth group 2 | Bandwidths 4, 5, and 6 |
| Bandwidth group 3 | Bandwidths 7, 8, and 9 |
| Bandwidth group 4 | Bandwidths 10, 11, and 12 |
| Bandwidth group 5 | Bandwidths 13 and 14 |
| Bandwidth group 6 | Bandwidths 9, 10, and 11 |

The ultra-wideband network according to an exemplary embodiment of the present invention will now be described with reference to FIG. 1.

The heterogeneous communication device 10 performs communication by using a predetermined communication scheme other than the UWB scheme. In this instance, the heterogeneous communication device 10 may correspond to a WiMax device, a 4-th generation mobile communication device, a broadcasting communication device, a military radio device, a broadcasting relay device, or a radio astronomic device. Also, the heterogeneous communication device 10 can transmit signals through the frequency bandwidth corresponding to the first bandwidth group from among the 6 bandwidth groups shown in FIG. 2, and in this instance, the signals transmitted by the heterogeneous communication device 10 may function as interference signals with part of a plurality of UWB communication devices.

In this instance, when the first UWB communication device 100 transmits a signal to the second UWB communication device 200 through the frequency bandwidth corresponding to the first bandwidth group from among the 6 bandwidth groups shown in FIG. 2, the first UWB communication device 100 detects the signal of the heterogeneous communication device 10 before transmitting the signal to the second UWB communication device 200 so as to not interfere with the heterogeneous communication device 10, and transmits the signal to the second UWB communication device 200 by avoiding the detected signal.

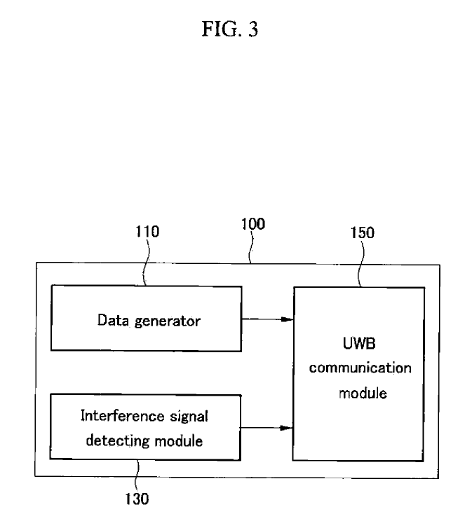

A UWB communication device according to an exemplary embodiment of the present invention will now be described with reference to FIG. 3.

FIG. 3 shows a UWB communication device according to an exemplary embodiment of the present invention.

As shown in FIG. 3, the first UWB communication device 100 according to an exemplary embodiment of the present invention includes a data generator 110, an interference signal detecting module 130, and an ultra-wideband (UWB) communication module 150.

The data generator 110 generates data to be transmitted to another UWB communication terminal included in the ultra-wideband network.

The interference signal detecting module 130 detects the interference signal received by the first UWB communication device 100, and generates interference signal detecting information based on the detected interference signal.

The UWB communication module 150 transmits ultra-wideband signals including the data generated by the data generator 110 based on the interference signal detecting information generated by the interference signal detecting module 130. Here, the ultra-wideband signals follow the UWB scheme.

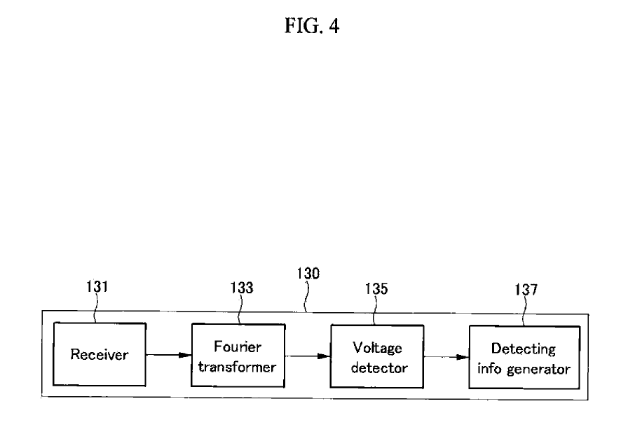

An interference signal detecting module according to an exemplary embodiment of the present invention will now be described with reference to FIG. 4.

FIG. 4 shows an interference signal detecting module according to an exemplary embodiment of the present invention.

As shown in FIG. 4, the interference signal detecting module 130 includes a receiver 131, a Fourier transformer 133., a voltage detector 135, and a detecting information generator 137.

The receiver 131 receives the interference signal.

The Fourier transformer 133 Fourier transforms the received interference signal to generate a plurality of subcarrier data corresponding to a plurality of subcarriers.

The voltage detector 135 detects voltage values of a plurality of subcarriers based on the plurality of subcarrier data.

The detecting information generator 137 generates interference signal detecting information including information on respective frequencies of the plurality of subcarriers and information on respective voltages of the plurality of subcarriers.

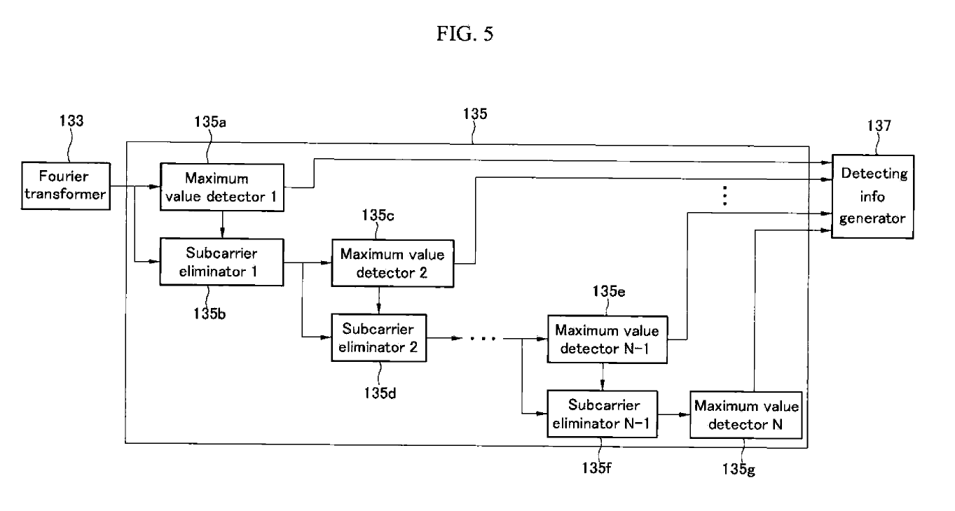

A voltage detector according to an exemplary embodiment of the present invention will now be described with reference to FIG. 5.

FIG. 5 shows a voltage detector according to another exemplary embodiment of the present invention.

As shown in FIG. 5, the voltage detector 135 includes a plurality of a maximum value detectors and a plurality of subcarrier eliminators.

In this instance, the voltage detector 135 can receive N subcarrier data from the Fourier transformer 133, and in this instance, it includes N maximum value detectors 135a, 135c, 135e, and 135g and N−1 subcarrier eliminators 135b, 135d, and 135f. The voltage detector 135 will be exemplified to receive N subcarrier data.

The first maximum value detector 135a extracts the data (the first subcarrier data) having the greatest voltage from among the N subcarrier data, detects corresponding frequency information and voltage value information on the first subcarrier from the extracted first subcarrier data, and outputs them. In this instance, the first maximum value detector 135a can transmit frequency information and voltage value information of the first subcarrier to the detecting information generator 137, and can transmit the first subcarrier data to the first subcarrier eliminator 135b.

The first subcarrier eliminator 135b receives the N subcarrier data and the first subcarrier data, eliminates the first subcarrier data from the N subcarrier data, and outputs N−1 subcarrier data.

The second maximum value detector 135c extracts the data (the second subcarrier data) having the greatest voltage value from among the N−1 subcarrier data, detects corresponding frequency information and voltage value information of the second subcarrier from the extracted second subcarrier data, and outputs them. In this instance, the second maximum value detector 135c can transmit frequency information and voltage value information of the second subcarrier to the detecting information generator 137, and can transmit the second subcarrier data to the second subcarrier eliminator 135d.

The second subcarrier eliminator 135d receives the N−1 subcarrier data and the second subcarrier data, eliminates the second subcarrier data from the N−1 subcarrier data, and outputs N−2 subcarrier data.

The (N−1)-th maximum value detector 135e extracts the data (the (N−1)-th subcarrier data) having the greater voltage from among the two subcarrier data, detects corresponding frequency information and voltage value information of the (N−1)-th subcarrier from the extracted (N−1)-th subcarrier data, and outputs them. In this instance, the (N−1)-th maximum value detector 135e can transmit frequency information and voltage value information of the (N−1)-th subcarrier to the detecting information generator 137, and can transmit the (N−1)-th subcarrier data to the (N−1)-th subcarrier eliminator 135f.

The (N−1)-th subcarrier eliminator 135f receives two subcarrier data and the (N−1)-th subcarrier data, eliminates the (N−1)th subcarrier data from the two subcarrier data, and outputs a subcarrier datum.

The N-th maximum value detector 135g detects frequency information and voltage value information of the N-th subcarrier corresponding to a subcarrier datum (the N-th subcarrier data) and outputs them. In this instance, the N-th maximum value detector 135g can transmit frequency information and voltage value information of the N-th subcarrier to the detecting information generator 137.

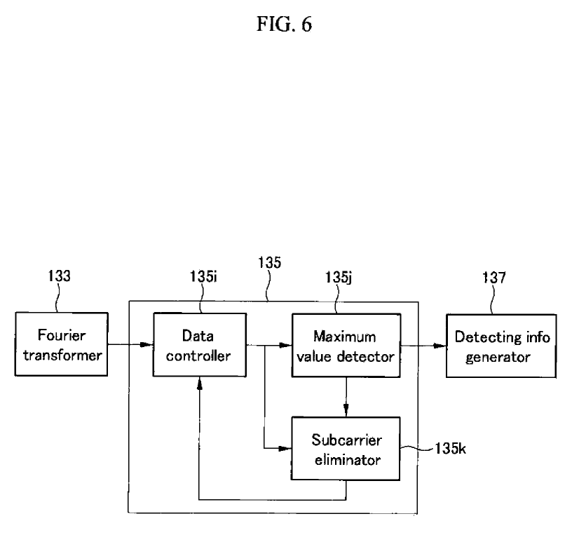

A voltage detector according to an exemplary embodiment of the present invention will now be described with reference to FIG. 6.

FIG. 6 shows a voltage detector according to another exemplary embodiment of the present invention.

As shown in FIG. 6, the voltage detector 135 includes a data controller 135i, a maximum value detector 135j, and a subcarrier eliminator 135k.

The data controller 135i receives data from the Fourier transformer 133 or the subcarrier eliminator 135k, and transmits the data to the maximum value detector 135j and the subcarrier eliminator 135k. In this instance, the data controller 135i may not transmit the data to the subcarrier eliminator 135k again when receiving a single datum from the subcarrier eliminator 135k.

The maximum value detector 135j receives a plurality of subcarrier data from the data controller 135i, extracts the data having the greatest voltage value from among the transmitted subcarrier data, detects corresponding frequency information and voltage value information of the subcarrier data from the extracted data, and outputs them. In this instance, the maximum value detector 135j can transmit frequency information and voltage value information of the detected subcarrier to the detecting information generator 137, and can transmit the extracted data to the subcarrier eliminator 135k.

The subcarrier eliminator 135k receives a plurality of subcarrier data from the data controller 135i, receives the extracted data from the data controller 135i, eliminates the extracted data from the plurality of subcarrier data, and transmits at least one subcarrier datum to the data controller 135i.

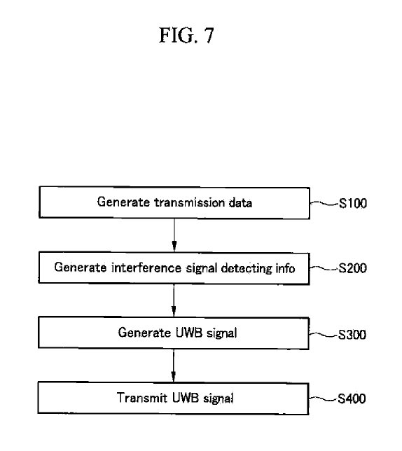

A method for a first UWB communication device according to an exemplary embodiment of the present invention to transmit ultra-wideband signals to a second UWB communication device will now be described with reference to FIG. 7 to FIG. 9.

FIG. 7 shows an ultra-wideband signal transmitting method according to an exemplary embodiment of the present invention.

As shown in FIG. 7, when the first UWB communication device 100 has data to be transmitted to the second UWB communication device 200, the data generator 110 generates transmission data (S100).

The interference signal detecting module 130 generates interference signal detecting information based on the signal (an interference signal) transmitted by the heterogeneous communication device 10 (S200). In this instance, the interference signal detecting information can include information on the respective frequencies of a plurality of subcarriers and information on the respective voltages of a plurality of subcarriers.

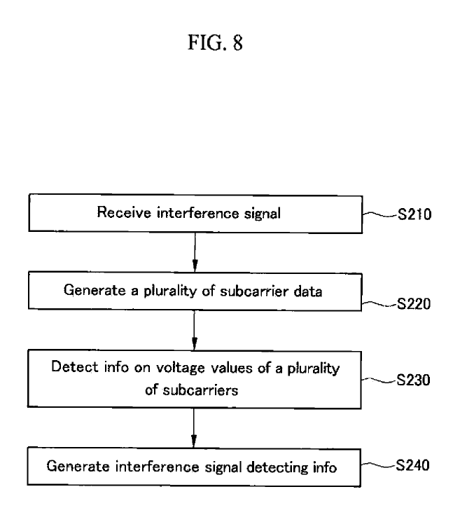

A method for an interference signal detecting module according to an exemplary embodiment of the present invention to generate interference signal detecting information will now be described with reference to FIG. 8.

FIG. 8 shows an interference signal detecting information generating method according to an exemplary embodiment of the present invention.

As shown in FIG. 8, the receiver 131 receives an interference signal (S210).

The Fourier transformer 133 Fourier transforms the interference signal to generate a plurality of subcarrier data corresponding to a plurality of subcarriers (S220).

The voltage detector 135 detects information on the respective frequencies of a plurality of subcarriers and information on the respective voltage values of a plurality of subcarriers based on a plurality of subcarrier data (S230).

The detecting information generator 137 generates interference signal detecting information including information on the respective frequencies of a plurality of subcarriers and information on the respective voltages of a plurality of subcarriers (S240).

A method for a first UWB communication device according to an exemplary embodiment of the present invention to transmit ultra-wideband signals to a second UWB communication device will now be described with reference to FIG. 7.

The UWB communication module 150 generates ultra-wideband signals including transmission data based on interference signal detecting information (S300).

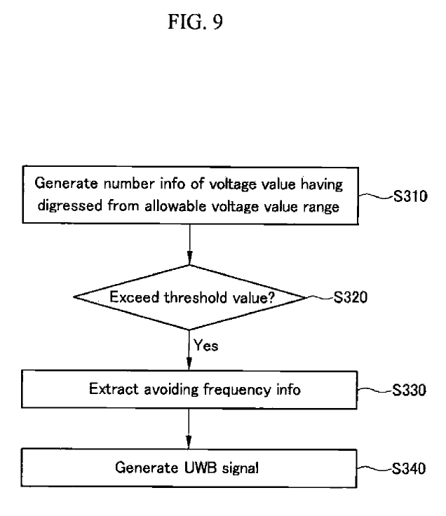

A method for a UWB communication module according to an exemplary embodiment of the present invention to generate ultra-wideband signals will now be described with reference to FIG. 9.

FIG. 9 shows an ultra-wideband signal generating method according to an exemplary embodiment of the present invention.

As shown in FIG. 9, the UWB communication module 150 generates number information of the voltage value (an avoiding voltage value) having digressed from the range of a predetermined allowable voltage value from among the respective voltage values of a plurality of subcarriers based on information on the respective voltage values of a plurality of subcarriers included in interference signal detecting information (S310).

The UWB communication module 150 determines whether the number of the avoiding voltage values exceeds a predetermined threshold value based on number information of the avoiding voltage values (S320). In this instance, the threshold value is greater than 1.

Here, when it exceeds the threshold value, the UWB communication module 150 extracts information (avoiding frequency information) on the respective frequencies of a plurality of avoiding subcarriers corresponding to a plurality of avoiding voltage values based on interference signal detecting information (S330).

Next, the UWB communication module 150 generates the ultra-wideband signal by modulating the transmission data according to the UWB scheme through the subcarriers of a predetermined bandwidth excluding the bandwidths to which the respective frequencies of a plurality of avoiding subcarriers from among a plurality of bandwidths based on avoiding frequency information (S340).

Further, when it does not exceed the threshold value, the UWB communication module 150 generates the ultra-wideband signals by modulating the transmission data through the subcarrier of a predetermined bandwidth.

A method for a first UWB communication device according to an exemplary embodiment of the present invention to transmit ultra-wideband signals to a second UWB communication device will now be described with reference to FIG. 7.

The first UWB communication device 100 transmits the ultra-wideband signals to the second UWB communication device 200 (S400).

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for transmitting a signal following an ultra-wideband scheme, comprising:
detecting information on respective frequencies of a plurality of subcarriers configuring an interference signal from the received interference signal and information on respective voltage values of the plurality of subcarriers; and
generating an ultra-wideband signal by modulating data according to the ultra-wideband scheme through subcarriers of part of the bandwidth from among a plurality of predetermined bandwidths based on information on the frequency and information on the voltage.

2. The method of claim 1, wherein
the detecting of the information includes:
generating a plurality of subcarrier data corresponding to a plurality of subcarriers by Fourier transforming the interference signal; and
detecting information on the frequency and information on the voltage value from the plurality of respective subcarrier data.

3. The method of claim 1, wherein
the generating of the ultra-wideband signal includes:
generating number information on the voltage values having digressed from the range of a predetermined allowable voltage according to information on the voltage value;
when a value corresponding to the number information is greater than a predetermined threshold value, extracting information on a frequency of a first subcarrier corresponding to a voltage value having digressed from the range of the allowable voltage value based on information on the frequency and information on the voltage value; and
generating the ultra-wideband signal by modulating the data according to the ultra-wideband scheme through the subcarrier of part of the bandwidth excluding the bandwidth to which the frequency of the first subcarrier belongs from among the plurality of bandwidths according to information on the frequency of the first subcarrier.

4. A device for transmitting a signal following an ultra-wideband scheme, comprising:
a data generator for generating data;
an interference signal detecting module for generating interference signal detecting information including information on respective voltage values of a plurality of subcarriers configuring an interference signal from the received interference signal; and
an ultra-wideband communication module for generating an ultra-wideband signal by modulating the transmission data according to the ultra-wideband scheme by using the interference signal detecting information.

5. The device of claim 4, wherein
the interference signal detecting module includes:
a Fourier transformer for generating a plurality of subcarrier data corresponding to a plurality of subcarriers by Fourier transforming the interference signal; and
a voltage detector for detecting information on the respective voltage values of the plurality of subcarriers from the plurality of subcarrier data.

6. The device of claim 5, wherein
the voltage detector includes:
a maximum value detector for extracting a first subcarrier data having the greatest voltage value from among the plurality of subcarrier data, and extracting voltage value information of a first subcarrier corresponding to the first subcarrier data from the first subcarrier data; and
a subcarrier eliminator for outputting part of the subcarrier data from among the plurality of subcarrier data by eliminating the first subcarrier data from the plurality of subcarrier data.

7. The device of claim 6, wherein
the voltage detector further includes
a data controller for transmitting the plurality of subcarrier data or the part of subcarrier data to the voltage detector and the subcarrier eliminator.

8. A device for detecting information from a signal comprising:
a receiver for receiving an interference signal;
a Fourier transformer for generating a plurality of subcarrier data corresponding to a plurality of subcarriers by Fourier transforming the interference signal; and
a voltage detector for detecting information on respective frequencies of the plurality of subcarriers and information on respective voltage values of the plurality of subcarriers based on the plurality of subcarrier data.

9. The device of claim 8, wherein
the voltage detector includes a maximum value detector for extracting subcarrier data having the greatest voltage value from among the plurality of subcarrier data, and detecting frequency information of the subcarrier corresponding to the subcarrier data from the subcarrier data and voltage value information of the subcarrier.

10. The device of claim 9, wherein
the voltage detector further includes a subcarrier eliminator for outputting part of subcarrier data by eliminating the subcarrier data from the plurality of subcarrier data.
